(19) United States
(12) Patent Application Publication
(10) Pub. No.: US 2023/0335788 A1
(43) Pub. Date: Oct. 19, 2023

(54) METHOD FOR PRODUCING ATOMIZATION SULFIDE SOLID ELECTROLYTE, ATOMIZATION SULFIDE SOLID ELECTROLYTE, ELECTRODE MIXTURE AND LITHIUM ION BATTERY

(71) Applicant: IDEMITSU KOSAN CO., LTD., Tokyo (JP)

(72) Inventors: Kenji MORIYAMA, Narashino-shi (JP); Shinji TANAKA, Ichihara-shi (JP); Katsuhito KONDO, Chiba-shi (JP); Hironari KIMPARA, Tokyo (JP); Atsushi YAO, Sodegaura-shi (JP)

(73) Assignee: IDEMITSU KOSAN CO., LTD., Tokyo (JP)

(21) Appl. No.: 18/123,384

(22) Filed: Mar. 20, 2023

(30) Foreign Application Priority Data
Mar. 22, 2022 (JP) 2022-045892

(51) Int. Cl. H01M 10/0562; H01M 10/0525

(52) U.S. Cl. CPC H01M 10/0562; H01M 10/0525; H01M 2300/0068

(57) ABSTRACT

Provided are a method for producing an atomization sulfide solid electrolyte, including atomizing a raw material sulfide solid electrolyte together with a specific ketone compound, the raw material sulfide solid electrolyte containing a lithium atom, a sulfur atom, a phosphorus atom and a halogen atom; an atomization sulfide solid electrolyte; an electrode mixture containing the atomization sulfide solid electrolyte and an electrode active material; and a lithium ion battery containing at least one of the atomization sulfide solid electrolyte and the electrode mixture.

### TECHNICAL FIELD

The present invention relates to a method for producing an atomization sulfide solid electrolyte, an atomization sulfide solid electrolyte, an electrode mixture, and a lithium ion battery.

### BACKGROUND ART

In recent years, with rapid spread of information-related equipment and communication equipment such as personal computers, video cameras, and mobile phones, the development of batteries used as power sources for the equipment has been emphasized. Conventionally, electrolytic solutions containing combustible organic solvents have been used in batteries for such applications. However, by making a battery completely solid, it is possible to simplify a safety apparatus without using a combustible organic solvent in the battery, and it is excellent in manufacturing cost and productivity. Therefore, lithium ion batteries in which the electrolytic solution is replaced with a solid electrolyte layer have been developed.

As the solid electrolyte layer, the use of a sulfide solid electrolyte with high lithium ion conductivity (hereinafter also simply referred to as ion conductivity) has been studied. A sulfide solid electrolyte is required to have a small particle size in order to improve the performance of a lithium ion battery. In a lithium ion battery, a positive electrode material, a negative electrode material, and an electrolyte are all solid, and when the particle size of the sulfide solid electrolyte is small, there is an advantage that it becomes easier to form a contact interface between an active material and the sulfide solid electrolyte and paths between ion conduction and electronic conduction are improved.

Examples of a method of reducing the particle size of a sulfide solid electrolyte (also referred to as “atomization”) include a production method including a step of adding an ether compound as a dispersion stabilizer to a coarse-grained material of a sulfide solid electrolyte material and atomizing by pulverization (see, for example, PTL 1), a production method using an amide, an amine salt, or an ester as a dispersion stabilizer (see, for example, PTL 2), a production method using a nitrile compound as a dispersant (see, for example, PTL 3), and a production method of wet pulverizing a lithium ion conductive sulfide together with an organic solvent and an ester compound (see, for example, PTL 4).

### CITATION LIST

### Patent Literature

PTL 1: JP 2013-020894 A
PTL 2: JP 2008-004459 A
PTL 3: JP 2012-134133 A
PTL 4: WO 2020/203231 A

### SUMMARY OF INVENTION

### Technical Problem

An object of the present invention is to provide a method for producing an atomization sulfide solid electrolyte, an atomization sulfide solid electrolyte, an electrode mixture, and a lithium ion battery.

### Solution to Problem

The method for producing an atomization sulfide solid electrolyte according to the present invention includes atomizing a raw material sulfide solid electrolyte together with a specific ketone compound, wherein
the raw material sulfide solid electrolyte contains a lithium atom, a sulfur atom, a phosphorus atom and a halogen atom;
the atomization sulfide solid electrolyte according to the present invention is an atomization sulfide solid electrolyte containing a specific ketone compound and a lithium atom, a sulfur atom, a phosphorus atom and a halogen atom;
the electrode mixture according to the present invention is an electrode mixture containing the atomization sulfide solid electrolyte and an electrode active material; and
the lithium ion battery according to the present invention is a lithium ion battery containing at least one of the atomization sulfide solid electrolyte and the electrode mixture.

### Advantageous Effects of Invention

According to the present invention, it is possible to provide a method for producing an atomization sulfide solid electrolyte, an atomization sulfide solid electrolyte, an electrode mixture, and a lithium ion battery.

### BRIEF DESCRIPTION OF DRAWINGS

FIG. 1 is a flow diagram illustrating a preferred embodiment of the method for producing an atomization sulfide solid electrolyte according to the present embodiment.

FIG. 2 is a spectrum chart obtained by FT-IR measurement of an atomization sulfide solid electrolyte obtained in Example 1.

FIG. 3 is an XRD pattern of each sulfide solid electrolyte.

FIG. 4 is a graph showing treatment time and particle size in Reference Example 1.

FIG. 5 is a graph of existence ratios between the particle size of the atomization sulfide solid electrolyte obtained in Example 1 and the particle size of a sulfide solid electrolyte of Comparative Example 1.

### DESCRIPTION OF EMBODIMENTS

Hereinafter, embodiments of the present invention (hereinafter sometimes referred to as “present embodiments”) will be described. In the present specification, upper and lower limits of numerical ranges of “equal to or more than”, equal to or less than“, and “to” are numerical values that can be arbitrarily combined, and the numerical values in the Examples can also be used as numerical values of” upper and lower limits.

### (Knowledge Obtained by Present Inventors to Reach Present Invention)

As a result of intensive studies aimed at solving the above-mentioned problems, the inventors of the present invention found the following matters and completed the present invention.

As can be seen from the above-mentioned patent literatures, a technology that achieves both atomization by pulverization and high ion conductivity has been studied for sulfide solid electrolytes, and a demand for a technology that can achieve both of these has been increasing.

In Example 1 of PTL 1, an atomized sulfide solid electrolyte is produced by performing wet mechanical milling of dibutyl ether and sulfide glass together with heptane. However, unlike the present embodiment, no ketone compound is used. Moreover, the ion conductivity of the resulting sulfide solid electrolyte is 1.3 mS/cm, and further improvement of the ion conductivity is required for use in a lithium ion battery.

In Example 2 of PTL 2, the sulfide solid electrolyte is pulverized using an ester-based nonionic activator as a dispersion stabilizer. Further, the sulfide solid electrolyte containing no halogen atoms is pulverized, and the object to be pulverized is different from the sulfide solid electrolyte of the present embodiment containing a halogen atom. For this reason, it is not known whether the same effect can be obtained with a sulfide solid electrolyte containing a halogen atom as in the present embodiment, and the ion conductivity of the obtained sulfide solid electrolyte powder is not disclosed.

In Example 1 of PTL 3, the sulfide solid electrolyte is treated by a bead mill together with isobutyronitrile. However, this is also a study on a sulfide solid electrolyte that does not contain a halogen atom like PTL 2, and there is no disclosure of the ion conductivity of the obtained sulfide solid electrolyte powder.

In Example 1 of PTL 4, a lithium ion conductive sulfide is treated by a wet pulverizer together with a hydrocarbon organic solvent (toluene) and an ester compound (butyl acetate). The resulting slurry was dried and then sieved with a sieve; however, since there is no description of the yield or the like, it is not known whether the slurry has been uniformly pulverized after pulverization, and there is no description of ion conductivity.

In PTLs 1 to 4, the solid electrolyte is treated with, together with a nitrile compound or an ester compound, an ether compound, an amide compound, or the like instead of containing a ketone compound, and thus the solid electrolyte after treatment contains these compounds. Therefore, the properties of the solid electrolyte are affected by these compounds. In addition, the solid electrolytes described in these references are different from a sulfide solid electrolyte containing a lithium atom, a sulfur atom, a phosphorus atom and a halogen atom such as the atomization sulfide solid electrolyte of the present embodiment. PTLs 1 to 4 either fail to disclose the ion conductivity of the obtained solid electrolytes, or even if disclosed, the ion conductivity was not sufficiently high, and there has been a demand for improvement.

As mentioned above, it is known to use an ester compound or a nitrile compound as a solvent or the like in atomization. In the future, mass production of sulfide solid electrolytes is becoming necessary in order to use the sulfide solid electrolytes in various products such as those described above. For large-scale production, it is necessary to prepare alternative compounds from the standpoint of ease of availability and ease of use, such as safety, with respect to materials to be used.

As an alternative compound for the above-mentioned ester compound and nitrile compound, in addition to the availability, it is necessary to function as a dispersant during the atomization of the raw material sulfide solid electrolyte, and not to impair the ion conductivity. The inventors of the present invention focused on ketone compounds as alternative compounds for the ester compounds and nitrile compounds. The inventors have found that when a ketone compound is used, it is possible to produce an atomization sulfide solid electrolyte having properties equal to or better than the properties obtained by atomization using an ester compound or a nitrile compound, and that a ketone compound can be used as an alternative compound.

More specifically, the inventors of the present invention have found that by atomizing the raw material sulfide solid electrolyte together with a specific ketone compound and removing the specific ketone compound as necessary, it is possible to improve the ion conductivity or suppress the decrease of the ion conductivity while reducing the average particle size (D₅₀). In addition, the inventors of the present invention have found that by making a lithium ion battery using an atomized atomization sulfide solid electrolyte, it is possible to obtain a lithium ion battery with excellent battery characteristics and having peroperties equivalent to or better than the properties obtained by atomization using an ester compound or a nitrile compound.

The method for producing an atomization sulfide solid electrolyte according to a first aspect to an eleventh aspect, the atomization sulfide solid electrolyte according to a twelfth aspect to a twentieth aspect, the electrode mixture according to a twenty-first aspect and the lithium ion battery according to a twenty-second aspect of the present embodiment will be described.

The method for producing an atomization sulfide solid electrolyte according to a first aspect of the present embodiment is

a method for producing an atomization sulfide solid electrolyte including atomizing a raw material sulfide solid electrolyte containing a lithium atom, a sulfur atom, a phosphorus atom and a halogen atom together with a ketone compound that has a boiling point of 70° C. or higher and 130° C. or lower.

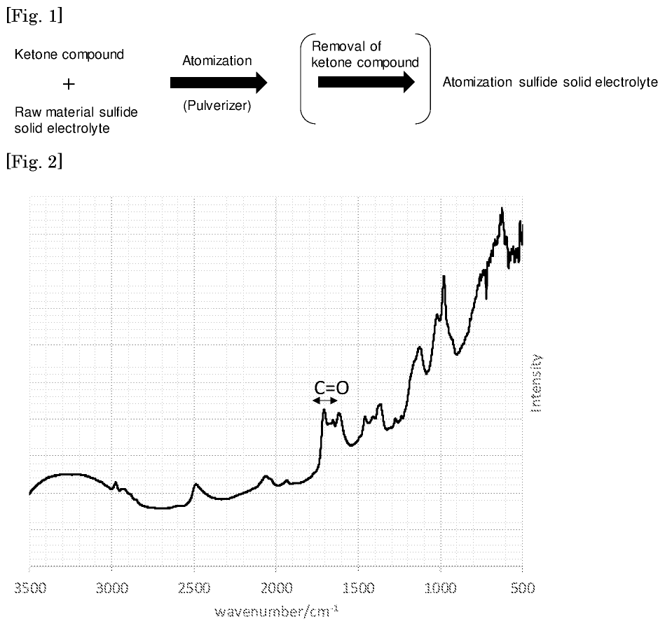

FIG. 1 shows a flow diagram illustrating a preferred embodiment of the method for producing an atomization sulfide solid electrolyte according to the present embodiment. The production method of the present embodiment uses a specific ketone compound as an alternative material instead of an ester compound or the like used in conventional production methods. In the production process, an atomization sulfide solid electrolyte having properties equal to or better than the properties of sulfide solid electrolytes obtained by conventional production methods can be obtained by only changing the materials used without the need to change the conventional production apparatus.

By atomizing the specific ketone compound and the raw material sulfide solid electrolyte, the generation of the modified sulfide solid electrolyte and the atomization of the generated modified sulfide solid electrolyte proceed simultaneously.

In the present application, “atomization” means to reduce the average particle size (D₅₀) of the sulfide solid electrolyte together with the specific ketone compound. This is a form of pulverization to be described later, and it is preferable to make D₅₀ 10 μm or less.

The atomization may be performed after part or all of the raw material sulfide solid electrolyte has become the modified sulfide solid electrolyte; however, it is preferable that the generation and atomization of the modified sulfide solid electrolyte proceed simultaneously.

In the present application, “modification” means mixing a specific ketone compound and a sulfide solid electrolyte to include the specific ketone compound in the sulfide solid electrolyte, and includes adhering the specific ketone compound to the sulfide solid electrolyte.

In addition, although the “modified sulfide solid electrolyte” is a sulfide solid electrolyte that has been modified, it is a sulfide solid electrolyte containing a specific ketone compound. As long as a specific ketone compound is contained, the aspect is not particularly limited, for example, it may be in a state of being simply “contained”, or it may be in a state of being “attached” by some physical or chemical force.

FT-IR (Fourier transform infrared spectrophotometry) can check whether a specific ketone compound is attached to the atomization sulfide solid electrolyte and the modified sulfide solid electrolyte. The existence of a specific ketone compound on the surface of the modified sulfide solid electrolyte can be determined by the presence or absence of an absorption peak (around 1600 to 1800 cm⁻¹) of a C═O stretching vibration of the carbonyl group characteristic of the ketone compounds. Whether a specific ketone compound is contained can be checked by methods described in the Examples.

When the modified sulfide solid electrolyte is atomized, the surface of the sulfide solid electrolyte that does not contain the specific ketone compound or does not contain a sufficient amount of the specific ketone compound appears. However, due to the presence of the specific ketone compound in the system, the surface also contains the specific ketone compound, which is preferable because granulation can be suppressed. In addition, since the modification of the raw material sulfide solid electrolyte and the atomization proceed simultaneously, the number of production steps can be reduced, which is preferable.

That the atomization sulfide solid electrolyte and the modified sulfide solid electrolyte “contain” a specific ketone compound and a sulfide solid electrolyte includes the attachment of the specific ketone compound to the surface of primary particles of the sulfide solid electrolyte as described later, and incorporation of the specific ketone compound into the sulfide solid electrolyte as a component constituting a crystal structure thereof. However, since it is preferable that the specific ketone compound is capable of being removed after atomization, it is preferable to be in a state of being “attached” to the surface of the primary particles of the sulfide solid electrolyte in order to increase the ion conductivity of the sulfide solid electrolyte.

The modified sulfide solid electrolyte is obtained by modifying a sulfide solid electrolyte. By atomizing the modified sulfide solid electrolyte and removing the specific ketone compound as necessary, an atomization sulfide solid electrolyte can be obtained, which can be used in a lithium ion battery to be described later.

Similar to the modified sulfide solid electrolyte, the atomization sulfide solid electrolyte contains a specific ketone compound. However, they differ in the average particle size thereof. The average particle size of the modified sulfide solid electrolyte is about the same as that of the raw material sulfide solid electrolyte, or is different from that of the atomization sulfide solid electrolyte in that the average particle size is larger than that of the atomization sulfide solid electrolyte after atomization. The atomization sulfide solid electrolyte is atomized, and the average particle size thereof is smaller than that of the raw material sulfide solid electrolyte, preferably 10 μm or less.

In the production method of the present embodiment, the raw material sulfide solid electrolyte, the modified sulfide solid electrolyte, and the atomization sulfide solid electrolyte are mixed at the time of atomization. At an initial stage of atomization, the ratio of the raw material sulfide solid electrolyte is large, and by continuing the atomization thereafter, the modified sulfide solid electrolyte is gradually generated and the ratio of the atomization sulfide solid electrolyte increases. Finally, an atomization sulfide solid electrolyte is produced as a main product.

The average particle size (D₅₀) is a particle size where 50% of the total particle sizes is reached by accumulating sequentially from the smallest particle size when a particle size distribution accumulation curve is drawn, and is an average particle size that can be measured using, for example, a laser diffraction/scattering particle size distribution analyzer for volume distribution. For example, the average particle size can be determined by a method described in the Examples.

By atomizing the sulfide solid electrolyte together with a specific ketone compound, the sulfide solid electrolyte obtained by atomization has a uniform and small average particle size and improved ion conductivity. Therefore, the present embodiment is an extremely excellent production method. In the conventional atomization treatment, it was thought that the sulfide solid electrolyte could be affected by insufficient atomization or by a compound to be added (for example, in PTL 4, a butyl acetate per se, a carboxylic acid generated by hydrolysis of butyl acetate, etc.). However, it was found that by “modifying” the raw material sulfide solid electrolyte with a specific ketone compound, granulation during atomization can be suppressed, a uniform and thin separator layer can be formed, and contact with a positive electrode active material can be improved. In addition, it was found that by removing the specific ketone compound from the atomization sulfide solid electrolyte, the ion conductivity of the atomization sulfide solid electrolyte obtained after atomization can be improved without affecting the atomization sulfide solid electrolyte. Here, the ion conductivity of the solid electrolyte can be determined, for example, by a method described in the Examples.

Although the reason why this is possible is not clear, this is probably because the polarity of the carbonyl group of the specific ketone compound makes it easier to be attached to the surface of the raw material sulfide solid electrolyte as described later, making it possible to uniformly attach to the surface of the sulfide solid electrolyte. In addition, it is hypothesized that, when removing the specific ketone compound as necessary, the specific ketone compound has moderately strong adhesion to the sulfide solid electrolyte, so it can be removed relatively easily, thus obtaining a sulfide solid electrolyte with high ion conductivity.

In the method for producing an atomization sulfide solid electrolyte according to the first aspect, a ketone compound having a boiling point of 70° C. or higher and 130° C. or lower is used. When the boiling point of the ketone compound is 70° C. or higher, the ketone compound makes it difficult for the primary particles to agglomerate, granulation is suppressed, and an atomization sulfide solid electrolyte with a small and uniform particle size can be obtained. In addition, when producing an electrode mixture or a lithium ion battery using an atomization sulfide solid electrolyte, it is preferable to reduce the content of the ketone compound after atomization in order to improve the ion conductivity. When the boiling point of the ketone compound is 130° C. or lower, the removal of the ketone compound to be described later can be easier.

The method for producing an atomization sulfide solid electrolyte according to a second aspect of the present embodiment is

a method for producing an atomization sulfide solid electrolyte including atomizing a raw material sulfide solid electrolyte containing a lithium atom, a sulfur atom, a phosphorus atom and a halogen atom together with a ketone compound, wherein the ketone compound is an aliphatic monoketone having 4 or more carbon atoms.

By atomizing the sulfide solid electrolyte together with an aliphatic monoketone having 4 or more carbon atoms, the sulfide solid electrolyte obtained by atomization has a uniform and small average particle size and improved ion conductivity. Therefore, the present embodiment is an extremely excellent production method. When the ketone compound is an aliphatic monoketone having 4 or more carbon atoms, the strength of the interaction with the sulfide solid electrolyte is within an appropriate range, making the attachment easier, and making the removal of the aliphatic monoketone easier.

The method for producing an atomization sulfide solid electrolyte according to a third aspect of the present embodiment is

a method for producing an atomization sulfide solid electrolyte including atomizing a raw material sulfide solid electrolyte containing a lithium atom, a sulfur atom, a phosphorus atom and a halogen atom together with a ketone compound, wherein the ketone compound is an aliphatic monoketone having at least one group having 2 or more carbon atoms as a group linked to a carbon atom forming a carbonyl group.

By atomizing a sulfide solid electrolyte together with an aliphatic monoketone having at least one group having 2 or more carbon atoms as a group linked to a carbon atom forming a carbonyl group, the sulfide solid electrolyte obtained by atomization has a uniform and small average particle size and improved ion conductivity. Therefore, the present embodiment is an extremely excellent production method. When the ketone compound is an aliphatic monoketone having at least one group having 2 or more carbon atoms as a group linked to a carbon atom forming a carbonyl group, the strength of the interaction with the sulfide solid electrolyte is within an appropriate range, making the attachment easier, and making the removal of the aliphatic monoketone easier.

As described above, in the method for producing an atomization sulfide solid electrolyte of the present embodiment, by using a specific ketone compound such as a ketone compound having a predetermined boiling point or a ketone compound having a predetermined structure, the strength of the interaction with the sulfide solid electrolyte is within an appropriate range, making the attachment easier, and also making the removal easier.

The method for producing an atomization sulfide solid electrolyte according to a fourth aspect of the present embodiment is

a method for producing an atomization sulfide solid electrolyte further including removing the ketone compound.

A ketone compound is preferable because it suppresses granulation at the time of atomization; however, since ion conductivity is improved by removing the ketone compound, for use in a lithium ion battery, it is preferable to remove the ketone compound before use.

The method for producing an atomization sulfide solid electrolyte according to a fifth aspect of the present embodiment is

a method for producing an atomization sulfide solid electrolyte in which the atomization is performed using a pulverizer.

By using a pulverizer for atomization, it is possible to atomize the modified sulfide solid electrolyte while modifying the sulfide solid electrolyte, which is preferable because the production process can be simplified.

The method for producing an atomization sulfide solid electrolyte according to a sixth aspect of the present embodiment is

a method for producing an atomization sulfide solid electrolyte in which the ketone compound in the first aspect is a compound represented by general formula (I).

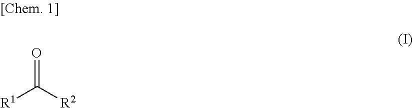

In the general formula (I), R¹ and R² each independently represent a monovalent hydrocarbon group having 1 to 8 carbon atoms, provided that when one of R¹ and R² is a methyl group, the other is a monovalent hydrocarbon group having 2 to 8 carbon atoms. The hydrocarbon groups of R¹ and R² may each independently have a linking group selected from —CH═CH—, —C≡C— and —O—.

When the ketone compound is a compound represented by the general formula (I), the strength of the interaction with the sulfide solid electrolyte is within an appropriate range, making the attachment easier, and also making the removal of the ketone compound easier. Moreover, since the ketone compound does not have a chemical effect, or even if it does, has a small chemical effect on the sulfide solid electrolyte, it is preferable to remove the ketone compound as necessary because the ion conductivity can be improved.

The method for producing an atomization sulfide solid electrolyte according to a seventh aspect of the present embodiment is

a method for producing an atomization sulfide solid electrolyte in which the total number of carbon atoms in R¹ and R² in the general formula (I) is 7 or less.

In a compound represented by the general formula (I), it is preferable that the total number of carbon atoms in R¹ and R² is 7 or less because the ketone compound is more likely to adhere to the sulfide solid electrolyte, the ketone compound can be easily removed, and the ion conductivity can be improved.

The method for producing an atomization sulfide solid electrolyte according to an eighth aspect of the present embodiment is

a method for producing an atomization sulfide solid electrolyte in which the ketone compound has a molecular weight of 150.00 or less.

When producing an electrode mixture or a lithium ion battery using an atomization sulfide solid electrolyte, in order to improve the ion conductivity, it is preferable to reduce the content of the ketone compound in the atomization sulfide solid electrolyte after the atomization. Therefore, it is preferable that the molecular weight of the ketone compound is 150.00 or less because the ketone compound can be easily removed as described later.

The method for producing an atomization sulfide solid electrolyte according to a ninth aspect of the present embodiment is

a method for producing an atomization sulfide solid electrolyte having an average particle size of 10 μm or less.

As described above, when the average particle size (D₅₀) can be made small, it is preferable because the battery characteristics are improved at the time of making into a lithium ion battery.

The method for producing an atomization sulfide solid electrolyte according to a tenth aspect of the present embodiment is

a method for producing an atomization sulfide solid electrolyte in which the atomization sulfide solid electrolyte contains an aldirodite type crystal structure.

It is preferable that the atomization sulfide solid electrolyte contains an aldirodite type crystal structure because the ionic conductivity is improved.

The method for producing an atomization sulfide solid electrolyte according to an eleventh aspect of the present embodiment is

a method for producing an atomization sulfide solid electrolyte further using a solvent together with a specific ketone compound.

It is preferable to atomize the raw material sulfide solid electrolyte together with a specific ketone compound and a solvent.

In the case of mass production of the sulfide solid electrolyte as described above, a large amount of a specific ketone compound is required for a large amount of raw material sulfide solid electrolyte. It is preferable to use a general-purpose solvent together with the specific ketone compound at the time of atomization, since the amount of the specific ketone compound that is an alternative compound to be used can also be reduced.

The atomization sulfide solid electrolyte according to a twelfth aspect of the present embodiment is

an atomization sulfide solid electrolyte containing a ketone compound having a boiling point of 70° C. or higher and 130° C. or lower, and a lithium atom, a sulfur atom, a phosphorus atom and a halogen atom.

The atomization sulfide solid electrolyte according to a thirteenth aspect of the present embodiment is

an atomization sulfide solid electrolyte containing a ketone compound, and a lithium atom, a sulfur atom, a phosphorus atom and a halogen atom, wherein the ketone compound is an aliphatic monoketone having 4 or more carbon atoms.

The atomization sulfide solid electrolyte according to a fourteenth aspect of the present embodiment is

an atomization sulfide solid electrolyte containing a ketone compound, and a lithium atom, a sulfur atom, a phosphorus atom and a halogen atom, wherein the ketone compound is an aliphatic monoketone having at least one group having 2 or more carbon atoms as a group linked to a carbon atom forming a carbonyl group.

In PTLs 1 to 4, the solid electrolyte is treated with, together with a nitrile compound or an ester compound, an ether compound, an amide compound, or the like instead of containing a specific ketone compound as in the twelfth to fourteenth aspects, and thus these compounds are contained. The solid electrolyte in PTLs 1 to 4 is different in that it is not a sulfide solid electrolyte containing a lithium atom, a sulfur atom, a phosphorus atom and a halogen atom as in the present application. PTLs 1 to 4 either fail to disclose the ion conductivity of the obtained solid electrolytes, or even if disclosed, the ion conductivity was not sufficiently high, and there has been a demand for improvement.

The atomization sulfide solid electrolyte containing a specific ketone compound means the same as the modified sulfide solid electrolyte containing a specific ketone compound.

However, as in the Examples and Comparative Examples to be described later, even if a specific ketone compound is contained, the specific ketone compound can be an alternative compound such as an ester compound and a nitrile compound as long as it exhibits the same properties as in a conventional case where an ester compound or a nitrile compound is contained.

The atomization sulfide solid electrolytes of the twelfth to fourteenth aspects are obtained by atomizing a sulfide solid electrolyte by the method for producing a sulfide solid electrolyte according to any one of the first to eleventh aspects. By removing the ketone compound as necessary, it is possible to produce an electrode mixture or a lithium ion battery to be described later using the atomization sulfide solid electrolytes, and thus is preferable.

The atomization sulfide solid electrolyte according to a fifteenth aspect of the present embodiment is an atomization sulfide solid electrolyte having a peak at 1600 to 1800 cm⁻¹ in an infrared absorption spectrum by FT-IR analysis (ATR method).

The peak around 1600 to 1800 cm⁻¹ is known as a peak derived from a carbonyl group. That is, the presence of a carbonyl group can be determined by having a peak around 1600 to 1800 cm⁻¹. Since the FT-IR analysis (ATR method) can observe the condition near the surface of a substance to be measured, it is possible to determine whether the ketone compound exists near the surface of the atomization sulfide solid electrolyte. By containing the ketone compound on the surface, it is possible to prevent granulation at the time of atomization and to atomize, and thus is preferable.

The atomization sulfide solid electrolyte according to a sixteenth aspect of the present embodiment is

an atomization sulfide solid electrolyte containing the specific ketone compound attached thereto.

“Attaching” includes physical adsorption, chemical bonding and coordinate bonding. The atomization sulfide solid electrolyte of the sixteenth aspect includes those in which a specific ketone compound is attached to the sulfide solid electrolyte by physical adsorption, chemical bonding, coordinate bonding, or a combination thereof. In the case of producing an electrode mixture or a lithium ion electrode using an atomization sulfide solid electrolyte, in order to improve the ion conductivity, it is preferable to further remove the ketone compound after the atomization to reduce the content of the ketone compound. It is preferable that the attachment is physical adsorption or coordinate bonding because the ketone compound is easily removed.

The atomization sulfide solid electrolyte according to a seventeenth aspect of the present embodiment is

an atomization sulfide solid electrolyte in which the ketone compound has a content of 1.00 parts by mass or less with respect to 100 parts by mass of the atomization sulfide solid electrolyte.

The ketone compound in the seventeenth aspect is a ketone compound that exists as a liquid contained in the atomization sulfide solid electrolyte and cannot be easily separated from the atomization sulfide solid electrolyte by drying, which will be described later.

It is preferable that the content of the ketone compound is within the range described above, since the ion conductivity is improved.

The content of the ketone compounds can be determined by a method described in the Examples, for example, by gas chromatography. In the methods described in the Examples, the ketone compound contained in the atomization sulfide solid electrolyte was eluted with methanol, and the content was determined.

The atomization sulfide solid electrolyte according to an eighteenth aspect of the present embodiment is

an atomization sulfide solid electrolyte containing the ketone compound attached to a surface of a primary particle of the atomization sulfide solid electrolyte.

It is preferable to contain the ketone compound attached to the surface of the primary particles of the sulfide solid electrolyte because granulation at the time of atomization can be prevented and the ketone compound can be easily removed. The ketone compound may be contained in the primary particles as well as on the surfaces of the primary particles.

The atomization sulfide solid electrolyte according to a nineteenth aspect of the present embodiment is

an atomization sulfide solid electrolyte in which the ketone compound is a compound represented by the aforementioned general formula (I).

When the ketone compound is a compound represented by the general formula (I), the strength of the interaction with the sulfide solid electrolyte is within an appropriate range, making the attachment easier, and also making the removal easier. In addition, since the reaction with the sulfide solid electrolyte is suppressed, deterioration of the sulfide solid electrolyte due to the ketone compound is also suppressed, which is preferable because the ion conductivity can be improved.

The atomization sulfide solid electrolyte according to a twentieth aspect of the present embodiment is

an atomization sulfide solid electrolyte containing an aldirodite type crystal structure.

It is preferable that the atomization sulfide solid electrolyte contains an aldirodite type crystal structure, because the ion conductivity of the atomization sulfide solid electrolyte is improved.

The electrode mixture according to a twenty-first aspect of the present embodiment is

an electrode mixture containing the atomization sulfide solid electrolyte according to the twelfth to twentieth aspects and an electrode active material.

Although the atomization sulfide solid electrolytes according to the twelfth to twentieth aspects may be used as they are, it is preferable to use them to produce an electrode mixture or a lithium ion battery after removing the ketone compound. The atomization sulfide solid electrolyte according to the twelfth to twentieth aspects has a small and uniform average particle size, and the atomization sulfide solid electrolyte after the ketone compound is removed has high ion conductivity. As a result, a lithium ion battery using the atomization sulfide solid electrolyte is preferable because it has excellent battery characteristics.

The lithium ion battery according to a twenty-second aspect of the present embodiment is

a lithium ion battery containing at least one of the atomization sulfide solid electrolyte according to the twelfth to twentieth aspects and the electrode mixture according to the twenty-first aspect.

Although the atomization sulfide solid electrolytes according to the twelfth to twentieth aspects may be used as they are, it is preferable to use them to produce an electrode mixture or a lithium ion battery after removing the ketone compound. The atomization sulfide solid electrolyte according to the twelfth to twentieth aspects has a small and uniform average particle size, and the atomization sulfide solid electrolyte after the ketone compound is removed has high ion conductivity. As a result, a lithium ion battery containing at least one of the atomization sulfide solid electrolyte according to the twelfth to twentieth aspects and the electrode mixture according to the twenty-first aspect is preferable because it has excellent battery characteristics.

The method for producing an atomization sulfide solid electrolyte, the atomization sulfide solid electrolyte, the electrode mixture, and the lithium ion battery of the present embodiment will be described in more detail below in accordance with the above-described embodiments.

### [Method for Producing Atomization Sulfide Solid Electrolyte]

The method for producing an atomization sulfide solid electrolyte according to the present embodiment should include atomizing a raw material sulfide solid electrolyte to be described later together with a specific ketone compound to be described later.

### <Atomization>

The atomization in the present embodiment is a form of pulverization as described above, with an object to atomize the raw material sulfide solid electrolyte to be described later or the modified sulfide solid electrolyte to be described later, and may be carried out at the same time as containing a specific ketone compound in the raw material sulfide solid electrolyte. In the present specification, pulverization for the purpose of atomization may also be described as grinding (atomization). By the atomization, an atomization sulfide solid electrolyte can be produced.

In the present embodiment, it is preferable to use a pulverizer for atomization. As a result, the raw material sulfide solid electrolyte described later or the modified sulfide solid electrolyte described later is preferable because it has a smaller average particle size, forms a uniform and thin separator layer and improves contact with the positive electrode active material. Furthermore, it is preferable to remove the ketone compound as necessary, since an atomization sulfide solid electrolyte with high ion conductivity can be obtained.

Atomization is a method that has conventionally been adopted as a mechanical milling method. As the pulverizer, for example, a medium-type pulverizer using a pulverizing medium can be used.

Medium-type pulverizers are roughly divided into container-driven pulverizers and medium-stirring pulverizers. Examples of the container-driven pulverizer include a stirring tank, a pulverizing tank, or a combination thereof, such as a ball mill and a bead mill. Examples of the medium-stirring pulverizer include an impact pulverizer such as a cutter mill, a hammer mill and a pin mill; a tower type pulverizer such as a tower mill; a stirring tank type pulverizer such as an attritor, an aquamizer and a sand grinder; a circulation tank type pulverizer such as a Visco mill and a pearl mill; a circulation tube type pulverizer; an annular type pulverizer such as a co-ball mill; a continuous dynamic pulverizer; and various pulverizers such as single-screw and multi-screw kneaders. Of these, a ball mill or a bead mill exemplified as the container-driven pulverizer is preferable in consideration of the ease of adjusting the particle size of the atomization sulfide solid electrolyte to be obtained.

These pulverizers can be appropriately selected according to desired scale, etc. For relatively small scales, a container-driven pulverizers such as a ball mill and a bead mill can be used. For large-scale or mass production, other types of pulverizers may be used.

In addition, as will be described later, when an object to be atomized is in a liquid state or a slurry state accompanied by a liquid ketone compound at the time of atomization, a wet pulverizer that can handle wet pulverization is preferable.

Typical examples of the wet pulverizer include a wet bead mill, a wet ball mill, and a wet vibration mill. A wet bead mill using beads as grinding media is preferable because the conditions for the grinding operation can be freely adjusted and it is easy to handle objects with smaller particle sizes. In addition, a dry pulverizer, for example, a dry medium pulverizer, such as a dry bead mill, a dry ball mill, a dry planetary ball mill and a dry vibration mill, or a dry non-medium pulverizer, such as a jet mill can also be used.

Moreover, when the object to be atomized is in a liquid state or a slurry state, a flow-type pulverizer capable of circulating and operating as necessary can also be used. Specifically, examples thereof include a pulverizer that enables circulation between a pulverizer (pulverization mixer) that pulverizes a slurry and a temperature holding tank (reaction vessel).

The size of the beads and balls used in the ball mill and bead mill may be appropriately selected according to desired particle size, treatment capacity, etc. For example, the diameter of the beads is usually 0.05 mmφ or more, preferably 0.1 mmφ or more, and more preferably 0.2 mmφ or more, and the upper limit is usually 5.0 mmφ or less, preferably 3.0 mmφ or less, and more preferably 2.0 mmφ or less. The diameter of the ball is usually 2.0 mmφ or more, preferably 2.5 mmφ or more, and more preferably 3.0 mmφ or more, and the upper limit is usually 30.0 mmφ or less, preferably 20.0 mmφ or less, and more preferably 15.0 mmφ or less.

Although the amount of beads or balls used varies depending on the scale of treatment and cannot be generalized, it is usually 100 g or more, preferably 200 g or more, and more preferably 300 g or more, and the upper limit is 5.0 kg or less, more preferably 3.0 kg or less, and still more preferably 1.0 kg or less.

In addition, examples of materials include metals, such as stainless steel, chrome steel, and tungsten carbide; ceramics, such as zirconia and silicon nitride; and minerals, such as agate.

Regarding the peripheral speed of a rotating body, a low peripheral speed and a high peripheral speed cannot be categorically defined because they can vary depending on the particle size, material, amount used, etc. of a medium used in the pulverizer. For example, in the case of an apparatus that does not use grinding media such as balls and beads, like a high-speed rotating thin-film stirrer, pulverization occurs mainly even at a relatively high peripheral speed, and granulation is difficult to occur. On the other hand, in the case of an apparatus using grinding media such as a ball mill and a bead mill, it is possible to pulverize at a low peripheral speed and granulate at a high peripheral speed as described above. Therefore, when predetermined conditions such as the pulverizing apparatus and the pulverizing medium are the same, the peripheral speed at which pulverization is possible is lower than the peripheral speed at which granulation is possible. Therefore, for example, under conditions where granulation is possible with a peripheral speed of 6 m/s as a border, a low peripheral speed means less than 6 m/s, and a high peripheral speed means 6 m/s or more.

Further, although the atomization time varies depending on the scale of the treatment and cannot be generalized, it is usually 10 minutes or longer, preferably 20 minutes or longer, more preferably 30 minutes or longer, and still more preferably 45 minutes or longer, and the upper limit is usually 72 hours or shorter, preferably 65 hours or shorter, and more preferably 52 hours or shorter. The range is preferable because granulation is suppressed and atomization proceeds.

Atomization can be performed by selecting the size and material of the medium (beads, balls) to be used, the number of rotations of a rotor, time, etc., and the particle size, etc. of the obtained atomization sulfide solid electrolyte can be adjusted.

In the above atomization, it is also preferable to further add a solvent together with the aforementioned ketone compound for atomization.

### (Solvent)

The solvent is preferably a hydrocarbon-based solvent that does not prevent the ketone compound from adhering to the raw material sulfide solid electrolyte, does not dissolve the sulfide solid electrolyte, and does not react with the sulfide solid electrolyte.

More specifically, an aliphatic hydrocarbon solvent, such as pentane, hexane, 2-ethylhexane, heptane, octane, decane, undecane, dodecane, and tridecane; an alicyclic hydrocarbon solvent, such as cyclohexane (8.2) and methylcyclohexane; an aromatic hydrocarbon solvent, such as benzene, toluene, xylene, mesitylene, ethylbenzene, tert-butylbenzene are preferred, toluene and ethylbenzene are more preferred, and toluene is even more preferred.

In the present embodiment, these solvents may be used alone or in combination of two or more kinds thereof.

In order to attach the ketone compound and obtain a desired average particle size by atomization, the solvent is, with respect to 100 parts by mass of the raw material sulfide solid electrolyte, preferably 1 part by mass or more and 50 parts by mass or less, preferably 2 parts by mass or more and 30 parts by mass or less, and preferably 5 parts by mass or more and 20 parts by mass or less.

### (Drying)

The method for producing an atomization sulfide solid electrolyte of the present embodiment preferably further includes drying and removing the ketone compound remaining as a liquid and the solvent used as necessary. By drying and removing, an atomization sulfide solid electrolyte powder is obtained. This enables more efficient removal of the ketone compound, which will be described later. The drying and removal of the ketone compound to be described later may be performed in the same step.

The drying may be performed at the same time as the removal of the ketone compound, which will be described later; however, an object of the drying is to remove the ketone compound remaining as a liquid and the solvent, and it is different from the step of removing the ketone compound contained in the atomization sulfide solid electrolyte.

Drying can be performed at a temperature depending on the type of ketone compound and solvent. For example, drying can be carried out at a temperature equal to or higher than the boiling point of the ketone compound or the solvent. In addition, drying can be carried out by drying under reduced pressure (vacuum drying) using a vacuum pump or the like, usually at 5 to 100° C., preferably 10 to 85° C., more preferably 15 to 70° C., and even more preferably at about room temperature (23° C.) (for example, at about room temperature ±5° C.), to volatilize the ketone compound and the solvent.

In addition, although the drying time varies depending on the scale of the treatment and cannot be generalized, it may be a period of time during which an atomization sulfide solid electrolyte can be obtained as a powder, and is usually 10 minutes or long, preferably 20 minutes or longer, more preferably 30 minutes or more, and still more preferably 45 minutes or more, and the upper limit is usually 72 hours or shorter, preferably 65 hours or shorter, and more preferably 52 hours or shorter.

Further, drying may be performed by filtration using a glass filter or the like, solid-liquid separation by decantation, or solid-liquid separation using a centrifugal separator or the like. In the present embodiment, drying under the above temperature conditions may be performed after performing solid-liquid separation.

Specifically, the solid-liquid separation can be easily carried out by decantation in which a suspension is transferred to a container, and after the solid has precipitated, the ketone compound that becomes a supernatant and the solvent that is added as necessary are removed, or by filtration using a glass filter having a pore size of about 10 to 200 μm, preferably 20 to 150 μm, for example.

### (Removal of Ketone Compound)

The method for producing an atomization sulfide solid electrolyte of the present embodiment preferably further includes removing the ketone compound contained in the atomization sulfide solid electrolyte. By removing the ketone compound contained in the atomization sulfide solid electrolyte, the ion conductivity is improved, and excellent battery characteristics are exhibited when a lithium ion battery is produced.

The removal of the ketone compound can be performed at a temperature depending on the type of the ketone compound. For example, it can be carried out at a temperature equal to or higher than the boiling point of the ketone compound. In addition, the removal can be carried out by drying under reduced pressure (vacuum drying) using a vacuum pump or the like, usually at 50° C. or higher and 200° C. or lower, preferably 70° C. or higher and 150° C. or lower, and more preferably 80° C. or higher and 130° C. or lower, to volatilize the ketone compound contained in the atomization sulfide solid electrolyte. The content of the ketone compound contained in the atomization sulfide solid electrolyte after removal of the ketone compound will be described later.

In addition, although the time for removing the ketone compound varies depending on the scale of the treatment and cannot be generalized, it is usually 10 minutes or long, preferably 20 minutes or longer, more preferably 30 minutes or more, and still more preferably 45 minutes or more, and the upper limit is usually 72 hours or shorter, preferably 65 hours or shorter, and more preferably 52 hours or shorter.

### (Heating)

The method for producing an atomization sulfide solid electrolyte preferably includes, as necessary, converting an amorphous atomization sulfide solid electrolyte into a crystalline atomization sulfide solid electrolyte, or allowing a crystal of the crystalline atomization sulfide solid electrolyte to grow more. This further improves the ion conductivity of the atomization sulfide solid electrolyte.

The heating temperature may be determined, for example, in the case of heating an amorphous atomization sulfide solid electrolyte to obtain a crystalline atomization sulfide solid electrolyte, according to the structure of the crystalline atomization sulfide solid electrolyte. The heating temperature for obtaining the crystalline atomization sulfide solid electrolyte varies depending on the structure of the obtained crystalline atomization sulfide solid electrolyte, and cannot be generally defined. However, the heating temperature is usually preferably 130° C. or higher, more preferably 200° C. or higher, and still more preferably 300° C. or higher, and although the upper limit is not particularly limited, it is preferably 550° C. or lower, more preferably 450° C. or lower, and still more preferably 430° C. or lower.

The heating time is not particularly limited as long as a desired crystalline atomization sulfide solid electrolyte is obtained. However, the heating time is, for example, preferably 1 minute or longer, more preferably 10 minutes or longer, still more preferably 30 minutes or longer, and even more preferably 1 hour or longer. In addition, although the upper limit of the heating time is not particularly limited, it is preferably 24 hours or shorter, more preferably 10 hours or shorter, still more preferably 5 hours or shorter, and even more preferably 3 hours or shorter.

Further, the heating is preferably performed in an inert gas atmosphere (for example, a nitrogen atmosphere, an argon atmosphere) or in a reduced pressure atmosphere (especially in a vacuum). This is because deterioration (for example, oxidation) of the atomization sulfide solid electrolyte can be prevented. The heating method is not particularly limited, and examples thereof include a method using a hot plate, a vacuum heating apparatus, an argon gas atmosphere furnace, or a firing furnace. Industrially, a horizontal dryer having a heating unit and a feed mechanism, a horizontal vibration fluid dryer, or the like may also be used, and it may be selected according to the treatment capacity of heating.

Similarly, the raw material sulfide solid electrolyte and the modified sulfide solid electrolyte may be heated as necessary.

### [Atomization Sulfide Solid Electrolyte]

The atomization sulfide solid electrolyte of the present embodiment is required to contain a specific ketone compound, a lithium atom, a sulfur atom, a phosphorus atom and a halogen atom.

The atomization sulfide solid electrolyte of the present embodiment can be produced by atomizing the raw material sulfide solid electrolyte through the atomization described above.

The atomization sulfide solid electrolyte is a sulfide solid electrolyte obtained by removing the ketone compound as necessary after adjusting the average particle size by atomization, which will be described later. It is preferable to remove the ketone compound as necessary after the atomization of the modified sulfide solid electrolyte, which will be described later, because a sulfide solid electrolyte with high ion conductivity and uniform particle size can be obtained. The atomization sulfide solid electrolyte thus obtained is preferably used, for example, as a solid electrolyte of a lithium ion battery.

The atomization sulfide solid electrolyte preferably has a peak at 1600 to 1800 cm⁻¹ in the infrared absorption spectrum by FT-IR analysis (ATR method). As described above, when the atomization sulfide solid electrolyte has a peak at 1600 to 1800 cm⁻¹, the ketone compound is present near the surface of the atomization sulfide solid electrolyte. This is preferable because an atomization sulfide solid electrolyte having a uniform particle size can be obtained by atomization.

The lower limit of the peak position is more preferably 1610 cm⁻¹ or more, still more preferably 1620 cm⁻¹ or more, and even more preferably 1630 cm⁻¹ or more. The upper limit of the peak position is more preferably 1770 cm⁻¹ or less, still more preferably 1750 cm⁻¹ or less, and even more preferably 1730 cm⁻¹ or less.

The “peak position” means the position of a peak top (cm⁻¹).

The atomization sulfide solid electrolyte preferably contains a specific ketone compound attached thereto, and it is preferable to contain the ketone compound attached to the surface of the primary particles of the atomization sulfide solid electrolyte because the granulation at the time of atomization is suppressed and the ketone compound can be easily removed.

Since the specific ketone compound is contained on the surface of the primary particles of the atomization sulfide solid electrolyte in this way, the specific ketone compound makes it difficult for the primary particles to agglomerate during atomization, thereby suppressing granulation. Therefore, this is preferable because an atomization sulfide solid electrolyte having a small and uniform particle size can be obtained. “Containing” is a concept including “attaching” as described above, and “attaching” includes physical adsorption, chemical bonding, and coordinate bonding.

The shape of the atomization sulfide solid electrolyte is not particularly limited, and may be matched with a shape required for the atomization sulfide solid electrolyte produced in the present embodiment or a shape required for a solid electrolyte of a lithium ion battery.

From the viewpoint that granulation can be effectively prevented at the time of atomization and the ketone compound can be easily removed, the content of the ketone compound with respect to 100 parts by mass of the atomization sulfide solid electrolyte before removal of the ketone compound is preferably 0.01 parts by mass or more and 3.00 parts by mass or less, more preferably 0.05 parts by mass or more and 1.00 parts by mass or less, still more preferably 0.10 parts by mass or more and 0.50 parts by mass or less, and even more preferably 0.15 parts by mass or more and 0.30 parts by mass or less.

From the viewpoint that the ion conductivity can be increased, the content of the ketone compound with respect to 100 parts by mass of the atomization sulfide solid electrolyte after the removal of the ketone compound is preferably 1.00 parts by mass or less, more preferably 0.80 parts by mass or less, still more preferably 0.50 parts by mass or less, and even more preferably 0.30 parts by mass or less. Although the lower limit is not particularly limited, it is preferably 0.01 parts by mass or more, and more preferably not substantially contained. Here, “substantially” means equal to or below the detection limit by the gas chromatography.

The content can be determined, for example, by a method described in the Examples using gas chromatography.

The shape of the atomization sulfide solid electrolyte is not particularly limited, and may be matched, for example, with a shape required for a solid electrolyte of a lithium ion battery, such as a particulate shape. The average particle size (D₅₀) of the particulate atomization sulfide solid electrolyte is preferably 10 μm or less. In order to form a uniform and thin separator layer and to improve the contact with a positive electrode active material, the average particle size is more preferably 5 μm or less, and still more preferably 3 μm or less. Although the lower limit is not particularly limited, it is preferably 0.01 μm or more, and more preferably 0.03 μm or more, from the viewpoint of ease of handling.

### <Modified Sulfide Solid Electrolyte>

The atomization sulfide solid electrolyte may be produced by removing the ketone compound as necessary after adjusting the average particle size of the modified sulfide solid electrolyte by the atomization.

The modified sulfide solid electrolyte contains a lithium atom, a sulfur atom, a phosphorus atom and a halogen atom in a content ratio derived from the raw material sulfide solid electrolyte that is to be modified to the modified sulfide solid electrolyte.

The modified sulfide solid electrolyte preferably contains a specific ketone compound attached thereto, and it is preferable to contain the specific ketone compound to be described later attached to the surface of the primary particles of the raw material sulfide solid electrolyte to be described later because the granulation at the time of atomization is suppressed and the specific ketone compound can be easily removed from the atomization sulfide solid electrolyte.

Since the specific ketone compound is contained on the surface of the primary particles of the raw material sulfide solid electrolyte in this way, the specific ketone compound makes it difficult for the primary particles to agglomerate during atomization, thereby suppressing granulation. Therefore, this is preferable because an atomization sulfide solid electrolyte having a small and uniform particle size can be obtained. “Containing” is a concept including “attaching” as described above, and “attaching” includes physical adsorption, chemical bonding, and coordinate bonding.

The shape of the modified sulfide solid electrolyte is not particularly limited, and may be matched with a shape required for the atomization sulfide solid electrolyte produced in the present embodiment or a shape required for a solid electrolyte of a lithium ion battery.

From the viewpoint that granulation can be effectively prevented at the time of atomization and the ketone compound can be easily removed, with respect to 100 parts by mass of the raw material sulfide solid electrolyte, the content of the ketone compound is preferably 0.01 parts by mass or more and 3.00 parts by mass or less, more preferably 0.05 parts by mass or more and 1.00 parts by mass or less, still more preferably 0.10 parts by mass or more and 0.50 parts by mass or less, and even more preferably 0.15 parts by mass or more and 0.30 parts by mass or less.

### <Ketone Compound>

The atomization sulfide solid electrolyte according to the twelfth aspect of the present embodiment is required to contain a ketone compound having a boiling point of 70° C. or higher and 130° C. or lower. When the boiling point of the ketone compound is 70° C. or higher, the ketone compound makes it difficult for the primary particles to agglomerate and suppresses granulation, resulting in an atomization sulfide solid electrolyte with a small and uniform particle size. When the boiling point of the ketone compound is 130° C. or lower, the ketone compound can be easily removed from the atomization sulfide solid electrolyte, resulting in improved ion conductivity. From such a viewpoint, the boiling point of the ketone compound is 70° C. or higher and 130° C. or lower, preferably 70° C. or higher and 120° C. or lower.

The ketone compound is not particularly limited as long as the boiling point satisfies the above range; however, in order to improve ion conductivity by atomization, a chain ketone is preferable from the viewpoint of not deteriorating the sulfide solid electrolyte and being easily attached and removed. In addition, in order to improve ion conductivity by atomization, a ketone compound having only one carbonyl group in a molecule thereof is preferable from the viewpoint that the sulfide solid electrolyte is hardly deteriorated and attachment and removal are easy.

A compound represented by the general formula (I) is preferable as the chain ketone. Since the strength of the interaction with the sulfide solid electrolyte falls within an appropriate range, the ketone compound becomes easy to attach and easy to remove. In addition, since the reaction with the sulfide solid electrolyte is suppressed, deterioration of the sulfide solid electrolyte due to the ketone compound is also suppressed, which is preferable because the ion conductivity can be improved.

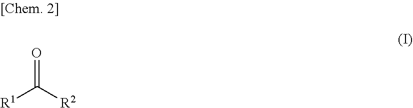

In the general formula (I), R¹ and R² each independently represent a monovalent hydrocarbon group having 1 to 8 carbon atoms, provided that when one of R¹ and R² is a methyl group, the other is a monovalent hydrocarbon group having 2 to 8 carbon atoms. The hydrocarbon groups of R¹ and R² may each independently have a linking group selected from —CH═CH—, —C≡C— and —O—.

In the general formula (I), R¹ and R² may be the same or different from each other. By appropriately selecting the R¹ and R², the boiling point of the ketone compound and the strength of the interaction with the sulfide solid electrolyte can be adjusted.

The monovalent hydrocarbon group having 1 to 8 carbon atoms is preferably a linear or branched alkyl group having 1 to 8 carbon atoms, a linear or branched alkenyl group having 2 to 8 carbon atoms, or a linear or branched alkynyl group having 2 to 8 carbon atoms. These groups may have an —O— group as a linking group, and from the viewpoint of suppressing deterioration of the sulfide solid electrolyte, a linear or branched alkyl group having 1 to 8 carbon atoms is more preferred. The linear or branched alkyl group having 1 to 8 carbon atoms is more preferably a methyl group, an ethyl group, an n-propyl group, an i-propyl group, an n-butyl group, a 2-methylpropyl group, a t-butyl group or an n-pentyl group. From the viewpoint of ease of removal, the total number of carbon atoms in R¹ and R² is preferably 7 or less, more preferably 4 or more and 7 or less.

The compound represented by the general formula (I) is preferably a methyl ethyl ketone (MEK), an isopropyl methyl ketone (IPMK), a diethyl ketone (3Pe), 2-pentanone, 4-methyl-2-pentanone (methyl isobutyl ketone, MIBK), a diisopropyl ketone (DK) or 2-hexanone (2He), more preferably a methyl ethyl ketone, a diethyl ketone, an isopropyl methyl ketone, 4-methyl-2-pentanone, a diisopropyl ketone or 2-hexanone, still more preferably a methyl ethyl ketone, a diethyl ketone, an isopropyl methyl ketone or 4-methyl-2-pentanone, and even more preferably a methyl ethyl ketone.

The atomization sulfide solid electrolyte according to the thirteenth aspect of the present embodiment is required to contain an aliphatic monoketone having 4 or more carbon atoms (hereinafter also referred to as an aliphatic monoketone (A)) as the ketone compound. When the ketone compound is an aliphatic monoketone (A), the primary particles are less likely to agglomerate and granulation is suppressed, resulting in an atomization sulfide solid electrolyte with a small and uniform particle size. Moreover, since the strength of the interaction with the sulfide solid electrolyte is within an appropriate range, the ketone compound becomes easy to attach and easy to remove. In addition, since the reaction with the sulfide solid electrolyte is suppressed, the deterioration of the sulfide solid electrolyte due to the ketone compound is also suppressed, resulting in improved ion conductivity.

The atomization sulfide solid electrolyte according to the fourteenth aspect of the present embodiment is required to contain, as a ketone compound, an aliphatic monoketone (hereinafter also referred to as an aliphatic monoketone (B)) having at least one group having 2 or more carbon atoms as a group linked to a carbon atom forming a carbonyl group. When the ketone compound is an aliphatic monoketone (B), the primary particles are less likely to agglomerate and granulation is suppressed, resulting in an atomization sulfide solid electrolyte with a small and uniform particle size. Moreover, since the strength of the interaction with the sulfide solid electrolyte is within an appropriate range, the ketone compound becomes easy to attach and easy to remove. In addition, since the reaction with the sulfide solid electrolyte is suppressed, the deterioration of the sulfide solid electrolyte due to the ketone compound is also suppressed, resulting in improved ion conductivity.

The group having 2 or more carbon atoms contained in the aliphatic monoketone (B) is preferably a monovalent hydrocarbon group having 2 to 8 carbon atoms. The monovalent hydrocarbon group having 2 to 8 carbon atoms is preferably a linear or branched alkyl group having 2 to 8 carbon atoms, a linear or branched alkenyl group having 2 to 8 carbon atoms, or a linear or branched alkynyl group having 2 to 8 carbon atoms. These groups may have an —O— group as a linking group, and from the viewpoint of suppressing deterioration of the sulfide solid electrolyte, a linear or branched alkyl group having 2 to 8 carbon atoms is more preferred. The linear or branched alkyl group having 2 to 8 carbon atoms is more preferably an ethyl group, an n-propyl group, an i-propyl group, an n-butyl group, a 2-methylpropyl group, a t-butyl group or an n-pentyl group.

The aliphatic monoketone (A) and the aliphatic monoketone (B) are preferably a methyl ethyl ketone (MEK), an isopropyl methyl ketone (IPMK), a diethyl ketone (3Pe), 4-methyl-2-pentanone (methyl isobutyl ketone, MIBK), a diisopropyl ketone (DK) or 2-hexanone (2He), more preferably a methyl ethyl ketone, a diethyl ketone, an isopropyl methyl ketone, 4-methyl-2-pentanone, a diisopropyl ketone or 2-hexanone, still more preferably a methyl ethyl ketone, a diethyl ketone, an isopropyl methyl ketone or 4-methyl-2-pentanone, and even more preferably a methyl ethyl ketone.

The boiling points of the aliphatic monoketone (A) and the aliphatic monoketone (B) are not particularly limited; however, from the viewpoint of facilitating removal from the atomization sulfide solid electrolyte, the boiling point is preferably 130° C. or lower, and more preferably 120° C. or lower. The lower limit is preferably 70° C. or higher.

The molecular weight of the ketone compound is preferably 150.00 or less, more preferably 120.00 or less, still more preferably 110.00 or less, and even more preferably 105.00 or less, in order to facilitate removal from the atomization sulfide solid electrolyte. Although the lower limit is not particularly limited, it is preferably 60.00 or more, and more preferably 70.00 or more.

### <Raw Material Sulfide Solid Electrolyte>

The raw material sulfide solid electrolyte of the present embodiment is required to contain a lithium atom, a sulfur atom, a phosphorus atom and a halogen atom.

The raw material sulfide solid electrolyte is a raw material for producing the modified sulfide solid electrolyte and the atomization sulfide solid electrolyte. The raw material sulfide solid electrolyte, the modified sulfide solid electrolyte, and the atomization sulfide solid electrolyte are all sulfide solid electrolytes, and these are solid electrolytes that have sulfur atoms in structures thereof, meaning electrolytes that remain solid at 25° C. under a nitrogen atmosphere.

### <Sulfide Solid Electrolyte>

The atomization sulfide solid electrolyte, the modified sulfide solid electrolyte, and the raw material sulfide solid electrolyte are sulfide solid electrolytes. The sulfide solid electrolyte in the present embodiment is a solid electrolyte that contains a lithium atom, a sulfur atom, a phosphorus atom and a halogen atom and that has ion conductivity attributable to a lithium atom.

“Solid electrolyte” includes both a crystalline sulfide solid electrolyte having a crystal structure obtained by the production method of the present embodiment and an amorphous solid electrolyte.

In the present specification, a crystalline sulfide solid electrolyte refers to a solid electrolyte in which a peak derived from a solid electrolyte is observed in an X-ray diffraction pattern in X-ray diffraction measurement, and it does not matter whether there is a peak derived from the raw material of the solid electrolyte. That is, the crystalline sulfide solid electrolyte includes a crystal structure derived from the solid electrolyte, and the crystal structure may be partly derived from the solid electrolyte or may be entirely derived from the solid electrolyte. Further, the crystalline sulfide solid electrolyte may partially contain an amorphous solid electrolyte as long as it has the X-ray diffraction pattern as described above. Therefore, the crystalline sulfide solid electrolyte contains so-called glass-ceramics obtained by heating the amorphous solid electrolyte to a crystallization temperature or higher.

In addition, in the present specification, an amorphous solid electrolyte refers to a halo pattern in which peaks other than peaks derived from materials are not substantially observed in an X-ray diffraction pattern in X-ray diffraction measurement, and it does not matter whether there is a peak derived from the raw material of the solid electrolyte.

The sulfide solid electrolyte includes a sulfide solid electrolyte containing a lithium atom, a sulfur atom, a phosphorus atom and a halogen atom, and is not particularly limited as long as it has ion conductivity attributable to lithium atoms. However, in order to improve the ion conductivity, it preferably has, for example, an aldirodite type crystal structure (JP 2011-096630 A, JP 2013-211171 A, etc.), such as Li₆PS₅X, Li₇₋ₓPS₆₋ₓXₓ (X═Cl, Br, I, x=0.0 to 1.8). In the present specification, “having as a main crystal” means that the ratio of a target crystal structure in the crystal structures is 80% or more, preferably 90% or more, and more preferably 95% or more.

The halogen atom is preferably a chlorine atom, a bromine atom or an iodine atom, more preferably a chlorine atom or a bromine atom, and still more preferably contains both a chlorine atom and a bromine atom.

The diffraction peaks of these aldirodite-based crystal structures appear, for example, near 20=15.3°, 17.7°, 31.1°, 44.9°, and 47.7°.

In addition, examples of the aldirodite-based crystal structures also include the following.

The crystal structures represented by composition formulas Li₇₋ₓP_{1-y}Si_{y}S₆ and Li₇₊ₓP_{1-y}Si_{y}S₆ (x is −0.6 to 0.6, y is 0.1 to 0.6), which have the structural skeleton of Li₇PS₆ and are formed by replacing part of P with Si, are cubic or orthorhombic, preferably cubic, and have peaks appearing mainly at positions of 2θ=15.5°, 18.0°, 25.0°, 30.0°, 31.4°, 45.3°, 47.0° and 52.0° in X-ray diffraction measurement using CuKα rays.

The crystal structure represented by the above composition formula Li_{7-x-2y}PS_{6-x-y}Clₓ (0.8≤x≤1.7, 0<y≤−0.25x+0.5) is preferably cubic and has peaks appearing mainly at positions of 2θ=15.5°, 18.0°, 25.0°, 30.0°, 31.4°, 45.3°, 47.0° and 52.0° in X-ray diffraction measurement using CuKα rays.

The crystal structure represented by the above composition formula Li₇₋ₓPS₆₋ₓHaₓ (Ha is Cl or Br, x is preferably 0.2 to 1.8) is preferably cubic and has peaks appearing mainly at positions of 2θ=15.5°, 18.0°, 25.0°, 30.0°, 31.4°, 45.3°, 47.0° and 52.0° in X-ray diffraction measurement using CuKα rays.

These peak positions may vary within a range of ±0.5°.

The sulfide solid electrolyte of the present embodiment preferably does not contain crystalline Li₃PS₄ (β-Li₃PS₄) in order to obtain higher ion conductivity. Whether or not it does not contain crystalline Li₃PS₄ (β-Li₃PS₄) can be determined by the presence or absence of diffraction peaks at 2θ=17.5° and 26.1° seen in crystalline Li₃PS₄. In the present specification, it is assumed that it does not contain crystalline Li₃PS₄ (β-Li₃PS₄) as long as it does not have the diffraction peaks or, even if it does, a very small peak compared to the diffraction peak of the aldirodite type crystal structure is detected.

When the sulfide solid electrolyte of the present embodiment has a chlorine atom in the structure thereof, it preferably does not contain crystalline Li₁₅P₄S₁₆Cl₃ in order to obtain higher ion conductivity. Whether or not it does not contain crystalline Li₁₅P₄S₁₆Cl₃ can be determined by the presence or absence of diffraction peaks at 2θ=19.6° and 23.3° seen in crystalline Li₁₅P₄S₁₆Cl₃. In the present specification, it is assumed that it does not contain crystalline Li₁₅P₄S₁₆Cl₃ as long as it does not have the diffraction peaks or, even if it does, a very small peak compared to the diffraction peak of the aldirodite type crystal structure is detected.

In the present embodiment, the amorphous solid electrolyte preferably becomes the crystalline sulfide solid electrolyte by crystallization such as heating, and the blending ratio (molar ratio) of the lithium atom, the sulfur atom, the phosphorus atom and the halogen atom is preferably the same as in the crystalline sulfide solid electrolyte.

### (Use of Atomization Sulfide Solid Electrolyte)

The atomization sulfide solid electrolyte of the present embodiment has a predetermined average particle size and specific surface area, high ion conductivity, and excellent battery performance. Moreover, since H₂S is hard to generate, the atomization sulfide solid electrolyte is suitably used for an electrode mixture for a lithium ion battery and a lithium ion battery.

It is particularly suitable when a lithium element is used as the conductive species. The atomization sulfide solid electrolyte of the present embodiment may be used in a positive electrode layer, a negative electrode layer, or an electrolyte layer.

In addition to the positive electrode layer, the electrolyte layer, and the negative electrode layer, the battery preferably uses a current collector, and known current collectors can be used. For example, a layer obtained by coating a material such as Au, Pt, Al, Ti, and Cu, which reacts with the atomization sulfide solid electrolyte, with Au or the like can be used.

### [Electrode Mixture]

The electrode mixture of the present embodiment is required to contain the atomization sulfide solid electrolyte and an electrode active material to be described later.

### (Electrode Active Material)

As the electrode active material, a positive electrode active material or a negative electrode active material is adopted depending on whether the electrode mixture is used for a positive electrode or a negative electrode.

As the positive electrode active material, in relation to the negative electrode active material, any material can be used without particular limitation as long as it can promote battery chemical reactions accompanied by movement of lithium ions caused by atoms, preferably lithium atoms, employed as atoms that exhibit ion conductivity. Examples of the positive electrode active material capable of intercalating and deintercalating lithium ions include an oxide-based positive electrode active material and a sulfide-based positive electrode active material.

Preferable examples of the oxide-based positive electrode active material include lithium-containing transition metal composite oxides, such as LMO (lithium manganate), LCO (lithium cobaltate), NMC (lithium nickel manganese cobaltate), NCA (lithium nickel cobalt aluminate), LNCO (lithium nickel cobaltate), and olivine type compounds (LiMeNPO₄, Me=Fe, Co, Ni, Mn).

Examples of the sulfide-based positive electrode active material include titanium sulfide (TiS₂), molybdenum sulfide (MoS₂), iron sulfide (FeS, FeS₂), copper sulfide (CuS), and nickel sulfide (Ni₃S₂).

In addition to the positive electrode active materials described above, niobium selenide (NbSe₃) and the like can also be used.

The positive electrode active material can be used alone or in combination of two or more kinds thereof.

As the negative electrode active material, any material can be used without particular limitation as long as it can promote battery chemical reactions accompanied by movement of lithium ions caused by atoms, preferably lithium atoms, employed as atoms that exhibit ion conductivity, preferably a metal capable of forming an alloy with a lithium atom, an oxide thereof, an alloy of the metal and a lithium atom, etc. As the negative electrode active material capable of intercalating and deintercalating lithium ions, any known negative electrode active material in the field of batteries can be employed without limitation.

Examples of the negative electrode active material include metal lithium, metal indium, metal aluminum, metal silicon, metal tin, and other metals capable of forming an alloy with metal lithium or metal lithium; oxides of these metals; and alloys of these metals and metal lithium.

The electrode active material used in the present embodiment may have a coating layer on which the surface is coated.

Examples of materials for forming the coating layer include ionic conductors, such as nitrides and oxides of atoms, preferably lithium atoms, which exhibit ion conductivity in a sulfide solid electrolyte, or composites thereof. Specifical examples thereof include a conductor having a lysicone type crystal structure, such as Li₄₋₂ₓZnₓGeO₄, with a main structure of lithium nitride (Li₃N) or Li₄GeO₄; a conductor having a thiolysicon type crystal structure, such as Li₄₋ₓGe₁₋ₓPₓS₄, with a Li₃PO₄ type skeleton structure; a conductor having a perovskite crystal structure, such as La_{2/3-x}Li₃ₓTiO₃; and a conductor having a NASICON type crystal structure such as LiTi₂(PO₄)₃.

Further examples thereof include lithium titanates such as Li_{y}Ti_{3-y}O₄ (0<y<3) and Li₄Ti₅O₁₂ (LTO), lithium metal oxides of metals belonging to Group 5 of the periodic table such as LiNbO₃ and LiTaO₃, and oxide-based conductors such as Li₂O—B₂O₃—P₂O₅-based, Li₂O—B₂O₃—ZnO-based, and Li₂O—Al₂O₃—SiO₂—P₂O₅—TiO₂-based conductors.

An electrode active material having a coating layer can be obtained, for example, by attaching a solution containing various atoms constituting the material forming the coating layer to the surface of the electrode active material, and firing the electrode active material after attachment at a temperature of preferably 200° C. or higher and 400° C. or lower.

Here, as the solution containing various atoms, for example, a solution containing alkoxides of various metals, such as lithium ethoxide, titanium isopropoxide, niobium isopropoxide, and tantalum isopropoxide may be used. In this case, as the solvent, an alcohol solvent, such as ethanol and butanol; an aliphatic hydrocarbon solvent, such as hexane, heptane and octane; an aromatic hydrocarbon solvent, such as benzene, toluene and xylene may be used.

Further, the above attachment may be performed by immersion, spray coating, or the like.

From the viewpoint of improving production efficiency and battery performance, the firing temperature is preferably 200° C. or higher and 400° C. or lower, and more preferably 250° C. or higher and 390° C. or lower, and the firing time is usually about 1 minute to 10 hours, and preferably 10 minutes to 4 hours.

The coverage of the coating layer is preferably 90% or more, more preferably 95% or more, and even more preferably 100%, based on the surface area of the electrode active material, that is, the entire surface is preferably covered. The thickness of the coating layer is preferably 1 nm or more, more preferably 2 nm or more, and the upper limit is preferably 30 nm or less, more preferably 25 nm or less.

The thickness of the coating layer can be measured by cross-sectional observation with a transmission electron microscope (TEM), and the coverage can be calculated from the thickness of the coating layer, an elemental analysis value, and a BET specific surface area.

### (Other Components)

The electrode mixture of the present embodiment may contain other components, such as a conductive material and a binder in addition to the atomization sulfide solid electrolyte and the electrode active material. That is, in a method for producing the electrode mixture of the present embodiment, in addition to the atomization sulfide solid electrolyte and the electrode active material, other components such as a conductive material and a binder may be used. Other components such as a conductive agent and a binder may be further added to and mixed with the atomization sulfide solid electrolyte and the electrode active material in mixing the atomization sulfide solid electrolyte and the electrode active material.

From the viewpoint of improving battery performance by improving electronic conductivity, examples of the conductive material include carbon-based materials, such as artificial graphite, graphite carbon fiber, resin baked carbon, pyrolytic vapor-grown carbon, coke, mesocarbon microbeads, furfuryl alcohol resin baked carbon, polyacene, pitch-based carbon fiber, vapor-grown carbon fiber, natural graphite, and non-graphitizable carbon.

By using a binder, the strength is improved when producing a positive and a negative electrode.

The binder is not particularly limited as long as it can impart functions such as binding properties and flexibility. Examples thereof include fluorine-based polymers, such as polytetrafluoroethylene and polyvinylidene fluoride; thermoplastic elastomers, such as butylene rubber and styrene-butadiene rubber; and various resins, such as acrylic resins, acrylic polyol resins, polyvinyl acetal resins, polyvinyl butyral resins, and silicone resins.

The blending ratio (mass ratio) of the electrode active material and the atomization sulfide solid electrolyte in the electrode mixture is preferably 99.5:0.5 to 40:60, more preferably 99:1 to 50:50, and still more preferably 98:2 to 60:40, in consideration of improving battery performance and production efficiency.

When a conductive material is contained, the content of the conductive material in the electrode mixture is not particularly limited. However, in consideration of improving battery performance and production efficiency, the content of the conductive material is preferably 0.5% by mass or more, more preferably 1% by mass or more, and still more preferably 1.5% by mass or more, and the upper limit is preferably 10% by mass or less, preferably 8% by mass or less, and more preferably 5% by mass or less.

In addition, when a binder is contained, the content of the binder in the electrode mixture is not particularly limited. However, considering the improvement of battery performance and production efficiency, the content of the binder is preferably 1% by mass or more, more preferably 3% by mass or more, and still more preferably 5% by mass or more, and the upper limit is preferably 20% by mass or less, more preferably 15% by mass or less, and still more preferably 10% by mass or less.

### [Lithium Ion Battery]

The lithium ion battery of the present embodiment is required to be a lithium ion battery containing at least one selected from the atomization sulfide solid electrolyte and the electrode mixture of the present embodiment.

The lithium ion battery of the present embodiment is not particularly limited in its structure as long as it contains either the atomization sulfide solid electrolyte of the present embodiment or an electrode mixture containing the same, and it may have a structure of a generally used lithium ion battery.

The lithium ion battery of the present embodiment preferably includes, for example, a positive electrode layer, a negative electrode layer, an electrolyte layer, and a current collector. The electrode mixture of the present embodiment is preferably used for the positive electrode layer and the negative electrode layer, and the atomization sulfide solid electrolyte of the present embodiment is preferably used for the electrolyte layer.

In addition, a known current collector may be used. For example, a layer obtained by coating a material such as Au, Pt, Al, Ti, and Cu, which reacts with the solid electrolyte, with Au or the like can be used.

The battery characteristics of a battery using the atomization sulfide solid electrolyte of the present embodiment can be evaluated, for example, by a charge/discharge test described in the Examples.

### EXAMPLES

Next, the present invention will be specifically described with reference to examples; however, the present invention is not limited to these examples.

### (1) Measurement Method

### (1-1) Volume-Based Average Particle Size (D₅₀)

It was measured with a laser diffraction/scattering particle size distribution analyzer (“Partica LA-950 (model number)”, manufactured by Horiba, Ltd.).

A mixture of dehydrated toluene (special grade, manufactured by Wako Pure Chemical Industries) and tertiary butyl alcohol (special grade, manufactured by Wako Pure Chemical Industries) at a weight ratio of 93.8:6.2 was used as a dispersion medium. After injecting 50 mL of the dispersion medium into a flow cell of the analyzer and circulating the dispersion medium, an object to be measured was added and subjected to ultrasonic treatment, and then the particle size distribution was measured. The added amount of the object to be measured was adjusted such that on a measurement screen specified by the analyzer, a red light transmittance (R) corresponding to the particle concentration falls within 80 to 90%, and a blue light transmittance (B) falls within 70 to 90%. Further, for calculation conditions, 2.16 was used as the refractive index value of the object to be measured, and 1.49 was used as the refractive index value of the dispersion medium. In setting a distribution form, the number of iterations was fixed at 15 and a particle size calculation was performed.

### (1-2) Measurement of Ion Conductivity

In the present Example, the ion conductivity was measured as follows.

Circular pellets with a diameter of 10 mm (cross-sectional area S: 0.785 cm²) and a height (L) of 0.1 to 0.3 cm were molded from the sulfide solid electrolytes obtained in Examples and Comparative Examples and were used as samples. Electrode terminals were taken from the top and bottom of the samples, and measurement was performed at 25° C. by an AC impedance method (frequency range: 1 MHz to 100 Hz, amplitude: 10 mV) to obtain a Cole-Cole plot. Near the right end of an arc observed in a high-frequency region, a real part Z′ (Ω) at a point where −Z″ (Ω) is minimum was used as a bulk resistance R (Ω) of the electrolyte, and ion Conductivity σ (S/cm) was calculated according to the following equation.

R=ρ(L/S)

σ=1/ρ

### (1-3) X-Ray Diffraction (XRD) Measurement

The sulfide solid electrolytes obtained in Examples or Comparative Examples were measured by XRD measurement.

The sulfide solid electrolyte powder produced in each example was filled in a groove with a diameter of 20 mm and a depth of 0.2 mm and was leveled with glass to obtain a sample. The sample was sealed with a Kapton film for XRD and measured without being exposed to air.

The measurement was conducted using a powder X-ray diffraction measurement apparatus D2 PHASER manufactured by BRUKER Co., Ltd. under the following conditions.
Tube voltage: 30 kV
Tube current: 10 mA
X-ray wavelength: Cu-Kα ray (1.5418 Å)
Optical system: concentration method
Slit configuration: using solar slit 4° (both incident side and light receiving side), divergence slit 1 mm, Kβ filter (Ni plate 0.5%), air scatter screen 3 mm
Detector: semiconductor detector
Measuring range: 2θ=10 to 60 deg
Step width, scan speed: 0.05 deg, 0.05 deg/sec

### (1-4) Measurement of Content of Ketone Compounds (Amount of Ketone Contained)

10 mL of methanol was added to 0.10 g of the sulfide solid electrolyte obtained in Examples 1 and 4 and Reference Example 1 to dissolve the solid electrolyte, thereby separating the ketone compound. The obtained solution was sampled and the content of the ketone compound in the solution was measured by gas chromatography (Shimadzu GC2030). From the obtained content, the content of the ketone compound in the atomization sulfide solid electrolyte (amount of ketone contained, % by mass) was calculated.

### (1-5) FT-IR Measurement (ATR Method)

Measuring apparatus: FR-IR spectrometer “FT/IR-6200”, manufactured by JASCO Corporation
Measurement method: diffuse reflection method
Measurement wavenumber range: 400 to 4000 cm⁻¹
Light source: high brightness ceramics light source (halogen lamp)
Detector: DLATGS
Resolution: 4 cm⁻¹
Measuring time: 1.2 seconds/time
Accumulated times: 100 times
Measurement conditions: measured using a sample obtained by introducing each powdered solid electrolyte into KBr diffuse reflection cell

It was determined that a ketone compound was attached to the modified sulfide solid electrolyte or the atomization sulfide solid electrolyte based on the presence or absence of a peak of absorption (FIG. 2 shows a spectrum chart obtained by FT-IR measurement of the atomization sulfide solid electrolyte obtained in Example 1, wherein the peak top is around 1600 to 1800 cm⁻¹. The position of absorption of C═O stretching vibration was illustrated.) of a C═O stretching vibration of a carbonyl group, which is characteristic of the ketone compound.

### (2) Materials Used

### (2-1) Preparation of Raw Material Sulfide Solid Electrolyte

A lithium sulfide (Li₂S), a phosphorus pentasulfide (P₂S₅), a lithium bromide (LiBr) and a lithium chloride (LiCl) were mixed in a glove box in a nitrogen atmosphere with a molar ratio of Li₂S:P₂S₅:LiBr:LiCl=47.5:12.5:15.0:25.0, which was weighed to a total of 110 g, and the mixture was put into a glass container and roughly mixed by shaking the container.

110 g of the roughly mixed raw material was dispersed in a mixed solvent of 720 mL of dehydrated toluene (manufactured by Wako Pure Chemical Industries, Ltd.) and 2.9 mL (2% by weight relative to the raw material) of dehydrated isobutyronitrile (manufactured by Kishida Chemical Co., Ltd.) under a nitrogen atmosphere to form a slurry of about 10% by weight.

The slurry was mixed and pulverized using a bead mill (LMZ015, manufactured by Ashizawa Finetech Co., Ltd.) while maintaining the nitrogen atmosphere. Specifically, 456 g of zirconia beads with a diameter of 0.5 mm were used as grinding media, the bead mill was operated at a peripheral speed of 12 m/s and a flow rate of 500 mL/min, and the slurry was put into the mill and circulated for 1 hour to obtain a mixture.

### (2-2) Heating (Crystallization) Step

After removing the solvent by drying the mixture obtained in (2-1) above with a vacuum pump, the mixture was heated (400 to 430° C.) for 2 hours in an electric furnace (F-1404-A, manufactured by Tokyo Glass Instruments Co., Ltd.) in a glove box under a nitrogen atmosphere. Thereafter, a raw material sulfide solid electrolyte was obtained by slow cooling.

As a result of X-ray diffraction (XRD) measurement of the obtained raw material sulfide solid electrolyte, peaks derived from an aldirodite type crystal structure were observed at 20=25.5±1.0 deg and 29.9±1.0 deg, etc. in the XRD pattern.

D₅₀ was 11.4 μm. Moreover, the ion conductivity was 4.6 mS/cm.

### (2-3) Dehydration of Ketone Compound and Solvent

The ketone compounds and solvents used in Examples, Reference Example 1 and Comparative Examples were used after adding 10 parts by mass of molecular sieves (3 A, manufactured by Kanto Kagaku Co., Ltd.) to 100 parts by mass of the ketone compound and solvent before use and allowing to stand still for 24 hours.

### Example 1

2.0 g of the raw material sulfide solid electrolyte obtained in (2-2) was dispersed in 18 g of dehydrated toluene (manufactured by Wako Pure Chemical Industries, Ltd.) as a solvent under a nitrogen atmosphere to obtain a slurry of about 10% by weight. Furthermore, 0.2 g of a ketone compound (dehydrated methyl ethyl ketone (MEK)) was added to the slurry, put into a planetary ball mill (model number P-7, manufactured by Fritsch) zirconia pot (45 mL) together with zirconia balls with a diameter of 0.3 mm, and completely sealed, and the inside of the pot was made an inert atmosphere (nitrogen atmosphere). Without heating and cooling (room temperature 23° C.), the planetary ball mill was used at a rotation speed of 150 rpm to atomize (atomization, mechanical milling) for 2 hours to obtain a slurry containing an atomization sulfide solid electrolyte.

The slurry after atomization for 2 hours was transferred to a nitrogen-substituted Schlenk bottle, dried at room temperature for 1 hour with a vacuum pump to remove liquid toluene and MEK, then heated to 80° C. to 100° C. to further remove (drying under reduced pressure) the ketone compound contained in the atomization sulfide solid electrolyte for 30 minutes to obtain an atomization sulfide solid electrolyte powder.

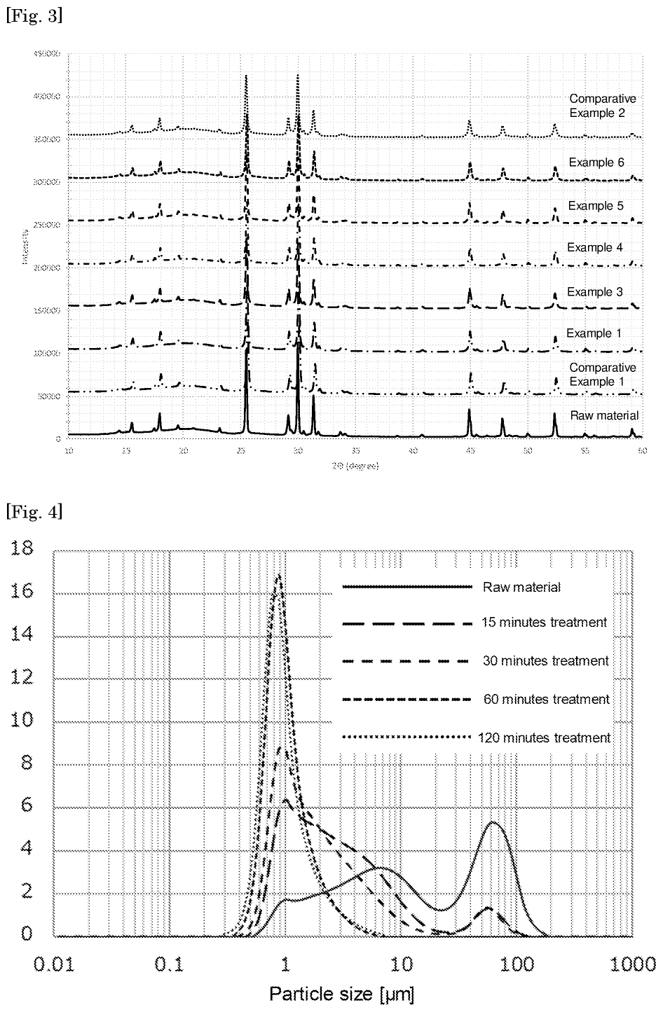

As a result of X-ray diffraction (XRD) measurement of the obtained atomization sulfide solid electrolyte (see FIG. 3), peaks derived from an aldirodite type crystal structure were observed at 2θ=25.5±1.0 deg and 29.9±1.0 deg, etc. in the XRD pattern, and it was confirmed to have an aldirodite type crystal structure.

Separately, atomization was terminated 10 minutes after the start of atomization, and as a result of checking D₅₀, a mixture of the modified sulfide solid electrolyte and the atomization sulfide solid electrolyte was confirmed from the particle size distribution and FT-IR measurement.

### Examples 2 to 6

An atomization sulfide solid electrolyte was obtained in the same manner as in Example 1, except that a compound shown in Table 1 was used as the ketone compound in an amount shown in Table 1. It was confirmed to have an aldirodite type crystal structure as in Example 1 (see FIG. 3).

### Reference Example 1

A sulfide solid electrolyte was obtained in the same manner as in Example 1, except that 0.4 g of iBuCN (isobutyronitrile) was used instead of the ketone compound.

FIG. 4 shows the particle size distribution of the raw material sulfide solid electrolyte used, the solid electrolyte after 15 minutes treatment, the solid electrolyte after 30 minutes treatment, the solid electrolyte after 60 minutes treatment, and the solid electrolyte after 120 minutes treatment. It can be seen that as the treatment time elapses, particles with large particle sizes decrease and the particles become uniform.

Similar results were obtained for Examples 1 to 6.

### Comparative Example 1

A sulfide solid electrolyte was obtained in the same manner as in Example 1, except that methyl ethyl ketone was not used.

### Comparative Example 2

A sulfide solid electrolyte was obtained in the same manner as in Example 1, except that 0.4 g of cyclohexanone (CH) was used as the ketone compound instead of dehydrated methyl ethyl ketone. It was confirmed to have an aldirodite type crystal structure as in Example 1 (see FIG. 3).

### Comparative Example 3

When 1.5 mL of acetone was added to 0.1 g of the raw material sulfide solid electrolyte obtained in (2-2) under a nitrogen atmosphere, agglomeration occurred after 1 to 2 minutes, and thus it was determined that the sulfide solid electrolyte was deteriorated due to acetone.

### Comparative Example 4

When 1.5 mL of acetylacetone was added to 0.1 g of the raw material sulfide solid electrolyte obtained in (2-2) under a nitrogen atmosphere, bubbling immediately occurred and the slurry turned red. Therefore, it was determined that the sulfide solid electrolyte was deteriorated due to acetylacetone.

Table 1 summarizes the recovery rate, D₅₀, the content of the ketone compound (ketone contained) and ion conductivity of the atomization sulfide solid electrolytes obtained in Examples 1 to 6 and the sulfide solid electrolytes obtained in Reference Example 1 and Comparative Examples 1 and 2. The recovery rate was obtained by dividing the atomization sulfide solid electrolyte by the mass of the raw material sulfide solid electrolyte×100(%). The content of ketone in Reference Example 1 is the content of iBuCN.

TABLE 1

| | Ketone compound | | | | Ketone | Ion |
|---|---|---|---|---|---|---|
| | | Amount | Recovery | | content | conduc- |
| | | used | rate | D₅₀ | % by | tivity |
| | | (g) | % | μm | mass | S/cm |
| Example 1 | MEK | 0.2 | 64.8 | 1.01 | 0.1 | 3.6 |
| Example 2 | MEK | 0.4 | 65.9 | 0.76 | — | 3.6 |
| Example 3 | IPMK | 0.2 | 69.2 | 0.9 | — | 3.4 |
| Example 4 | 3Pe | 0.4 | 63.3 | 0.85 | 0.2 | 4.0 |
| Example 5 | DK | 0.4 | 63.4 | 1.86 | — | 3.4 |
| Example 6 | 2He | 0.2 | 69.2 | 0.74 | — | 3.5 |
| Reference | iBuCN | 0.4 | 64.8 | 1.04 | 0.3 | 4.0 |
| Example 1 | | | | | | |
| Comparative | Not used | | 8.8 | 1.17 | — | — |
| Example 1 | | | | | | |
| Comparative | CH | 0.4 | 61.8 | 0.62 | — | 2.3 |
| Example 2 | | | | | | |

| | | | | | |
|---|---|---|---|---|---|
| Raw material | Not used | — | 11.39 | — | 4.6 |

In the table, MEK represents methyl ethyl ketone, IPMK represents isopropyl methyl ketone, 3Pe represents diethyl ketone, DK represents diisopropyl ketone, 2He represents 2-hexanone, and CH represents cyclohexanone. The iBuCN in the ketone compound column represents isobutyronitrile used in place of the ketone compound, and “not used” represents that no ketone compound was used. The raw material represents the raw material sulfide solid electrolyte obtained in (2-2).

From the results of Examples 1 to 6, it was confirmed that, similar to the sulfide solid electrolyte of Reference Example 1, the atomization sulfide solid electrolyte of the present invention has a small D₅₀ and a large ion conductivity. Moreover, it can be determined that when an electrode mixture is produced from these atomization sulfide solid electrolytes and further made into a lithium ion battery, the battery characteristics are excellent, and it was found that the ketone compound can be used as a substitute for the nitrile compound.

On the other hand, it can be seen that although the sulfide solid electrolyte of Comparative Example 2 using cyclohexanone as a ketone compound has a small D₅₀, the ion conductivity thereof is lower than that of the atomization sulfide solid electrolyte of the present invention and the sulfide solid electrolyte of Reference Example 1. It is considered that this is because cyclohexanone has a cyclic structure, which deteriorates the sulfide solid electrolyte and lowers the ion conductivity.

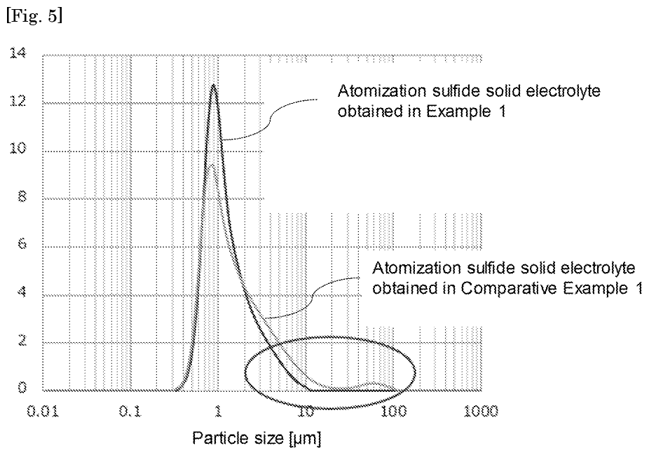

FIG. 5 shows a graph of the particle size distribution of the atomization sulfide solid electrolyte obtained in Example 1 and the sulfide solid electrolyte of Comparative Example 1. It was found that similar to the sulfide solid electrolyte obtained in Reference Example 1, by atomization, the atomization sulfide solid electrolyte obtained in Example 1 has a sharp peak and a uniform particle size. Similar results were obtained for the atomization sulfide solid electrolytes obtained in Examples 2 to 6.

The recovery rate of the sulfide solid electrolyte of Comparative Example 1 produced without using a ketone compound is significantly low. This is because the solid electrolyte agglomerated and adhered to the zirconia balls and the zirconia pot during atomization and could not be recovered. In the production method of the present embodiment, such agglomeration and adhesion are suppressed, and thus not only the deterioration of yield when performing large-scale production, but also an increase in maintenance frequency and equipment failure due to clogging of the production apparatus can be suppressed. Therefore, it can be said that it is an extremely excellent production method.

Furthermore, although the D₅₀ of the sulfide solid electrolyte obtained in Comparative Example 1 was small, as shown in FIG. 5, a peak that is not seen in the atomization sulfide solid electrolyte obtained in Example 1 was observed near the particle size of 60 μm of the sulfide solid electrolyte of Comparative Example 1. The peak near 60 μm is considered to be particles generated by granulation at the time of pulverization (atomization). It was found that the atomization sulfide solid electrolytes of the Examples that did not contain the peak were sulfide solid electrolytes with more uniform particle sizes than those of Comparative Example 1.

### INDUSTRIAL APPLICABILITY

According to the present embodiment, it is possible to provide a method for producing an atomization sulfide solid electrolyte that is extremely useful for obtaining an atomized sulfide solid electrolyte, the atomization sulfide solid electrolyte, an electrode mixture containing the atomization sulfide solid electrolyte and an electrode active material, and a lithium ion battery containing at least one of the atomization sulfide solid electrolyte and the electrode mixture. The atomization sulfide solid electrolyte of the present embodiment is suitably used as a material for batteries, particularly for batteries used in information-related equipment and communication equipment such as personal computers, video cameras, and mobile phones.

1. A method for producing an atomization sulfide solid electrolyte, comprising atomizing a raw material sulfide solid electrolyte together with a ketone compound,
the raw material sulfide solid electrolyte containing a lithium atom, a sulfur atom, a phosphorus atom and a halogen atom,
wherein the ketone compound has a boiling point of 70° C. or higher and 130° C. or lower.

2-3. (canceled)

4. The method for producing an atomization sulfide solid electrolyte according to claim 1, further comprising removing the ketone compound.

5. The method for producing an atomization sulfide solid electrolyte according to claim 1, wherein the atomization is performed using a pulverizer.

6. The method for producing an atomization sulfide solid electrolyte according to claim 1, wherein the ketone compound is a compound represented by the following general formula (I), 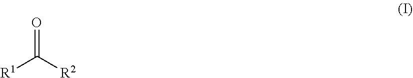
wherein R¹ and R² each independently represent a monovalent hydrocarbon group having 1 to 8 carbon atoms, provided that when one of R¹ and R² is a methyl group, the other is a monovalent hydrocarbon group having 2 to 8 carbon atoms; the hydrocarbon groups of R¹ and R² may each independently have a linking group selected from —CH═CH—, —C≡C— and —O—.

7. The method for producing an atomization sulfide solid electrolyte according to claim 6, wherein a total number of carbon atoms in R¹ and R² in the general formula (I) is 7 or less.

8. The method for producing an atomization sulfide solid electrolyte according to claim 1, wherein the ketone compound has a molecular weight of 150.00 or less.

9. The method for producing an atomization sulfide solid electrolyte according to claim 1, wherein an average particle size is 10 μm or less.

10. The method for producing an atomization sulfide solid electrolyte according to claim 1, wherein the atomization sulfide solid electrolyte contains an aldirodite type crystal structure.

11. The method for producing an atomization sulfide solid electrolyte according to claim 1, further using a solvent together with a ketone compound.

12. An atomization sulfide solid electrolyte, comprising
a ketone compound, and
a lithium atom, a sulfur atom, a phosphorus atom and a halogen atom,
wherein the ketone compound has a boiling point of 70° C. or higher and 130° C. or lower.

13-14. (canceled)

15. The atomization sulfide solid electrolyte according to claim 12, having a peak at 1600 to 1800 cm⁻¹ in an infrared absorption spectrum by FT-IR analysis (ATR method).

16. The atomization sulfide solid electrolyte according to claim 12, containing the ketone compound attached thereto.

17. The atomization sulfide solid electrolyte according to claim 12, wherein the ketone compound has a content of 1.00 parts by mass or less with respect to 100 parts by mass of the atomization sulfide solid electrolyte.

18. The atomization sulfide solid electrolyte according to claim 12, containing the ketone compound attached to a surface of a primary particle of the atomization sulfide solid electrolyte.

19. The atomization sulfide solid electrolyte according to claim 12, wherein the ketone compound is a compound represented by the following general formula (I), 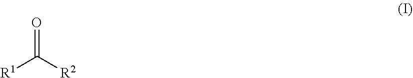
wherein R¹ and R² each independently represent a monovalent hydrocarbon group having 1 to 8 carbon atoms, provided that when one of R¹ and R² is a methyl group, the other is a monovalent hydrocarbon group having 2 to 8 carbon atoms; the hydrocarbon groups of R¹ and R² may each independently have a linking group selected from —CH═CH—, —C≡C— and —O—.

20. The atomization sulfide solid electrolyte according to claim 12, containing an aldirodite type crystal structure.

21. An electrode mixture comprising the atomization sulfide solid electrolyte according to claim 12 and an electrode active material.

22. A lithium ion battery comprising the atomization sulfide solid electrolyte according to claim 12.

23. A lithium ion battery according to claim 22, further comprising an electrode active material.
